(19) United States
(12) Patent Application Publication
(10) Pub. No.: US 2020/0130825 A1
(43) Pub. Date: Apr. 30, 2020

(54) NEUTRAL AXIS DUCT WITH TANDEM TELESCOPIC THRUST VECTORING LEADING AND TRAILING EDGE PROPELLERS FOR MULTI-MODE SPATIAL VEHICLE

(71) Applicant: PRASAD MUTHUKUMAR, Tamil Nadu (IN)

(72) Inventor: PRASAD MUTHUKUMAR, Tamil Nadu (IN)

(21) Appl. No.: 16/472,228

(22) PCT Filed: Feb. 20, 2018
(86) PCT No.: PCT/IN2018/000012

§ 371 Date: Jun. 24, 2019

(30) Foreign Application Priority Data
Feb. 21, 2017 (IN) 201741006025

(51) Int. Cl. B64C 37/00; B64C 3/56; B64C 3/58; B64C 5/12; B64C 9/00; B64C 11/30; B64C 13/50; B64C 15/14; B64C 29/00; B64D 27/02; B64D 35/04; B60F 3/00; B60F 5/00; B60L 50/60; B62D 35/00; B62D 21/02; B62D 23/00

(52) U.S. Cl. CPC B64C 37/00; B63B 2241/20; B64C 3/58; B64C 5/12; B64C 9/00; B64C 11/30; B64C 13/503; B64C 15/14; B64C 29/0033; B64D 27/02; B64D 35/04; B60F 3/0007; B60F 5/003; B60L 50/60; B62D 35/00; B62D 21/02; B62D 23/00; B63B 38/00; B64D 2027/026; B60L 2200/10; B60L 2200/32; B64C 3/56

(57) ABSTRACT

Neutral Axis Duct with Tandem Telescopic Thrust Vectoring Leading and Trailing Edge Propellers for Multi-Mode Spatial Vehicle [NADTVPMSV] is a single monocoque chassis frame for a multi-mode vehicle that can travel in all land, air, over water and under water as a perfect road vehicle, perfect flying machine, perfect speed boat and perfect submarine. NADTVPMSV comprising of a longitudinal and transverse ducts with tandem thrust vectoring leading and trailing edge propellers integrated with at least one concealed or non-concealed leading and trailing bidirectional edge thrust vectoring propeller propellers connected with shaft and power source like motor or engine for providing vertical, horizontal and angular thrust to monocoque chassis frame; retractable under chassis wings with single to multi directional fluid flow design, opening and closing mechanism to control the flight as well as to adapt according to mode of the vehicle; one or more wheel tires and suspension components for the vehicle with at least one steerable wheel to travel on surface; at least one ballast tank to submerge and manoeuvre the vehicle under water.

### FIELD OF INVENTION

The present invention is related to transportation vehicle, more particularly into multi-mode vehicles that can travel in land, air, over water and under water

### OBJECTIVE

The primary aim of the present invention is to provide a highly practical and functional design in making a single vehicle that is a perfect road car, perfect flying machine, perfect speedboat and perfect submarine.

### BACKGROUND AND PROBLEM STATEMENT

There are lot challenges involved in designing a functional hybrid road and flying car. Some of the primary challenges are dimensions like size and shape which are highly restricted. So when the dimensions of the designs are reduces to accommodate the road and parking there needs to be a lot of compromise on flying ability.

Another main drawback with the other proposed designs for the market are not a traditional looking vehicle and with lot of exposed components.

Another main drawback with the other proposed designs are compromise of on road performance, safety, driving dynamics.

### BRIEF DESCRIPTION OF DIAGRAMS

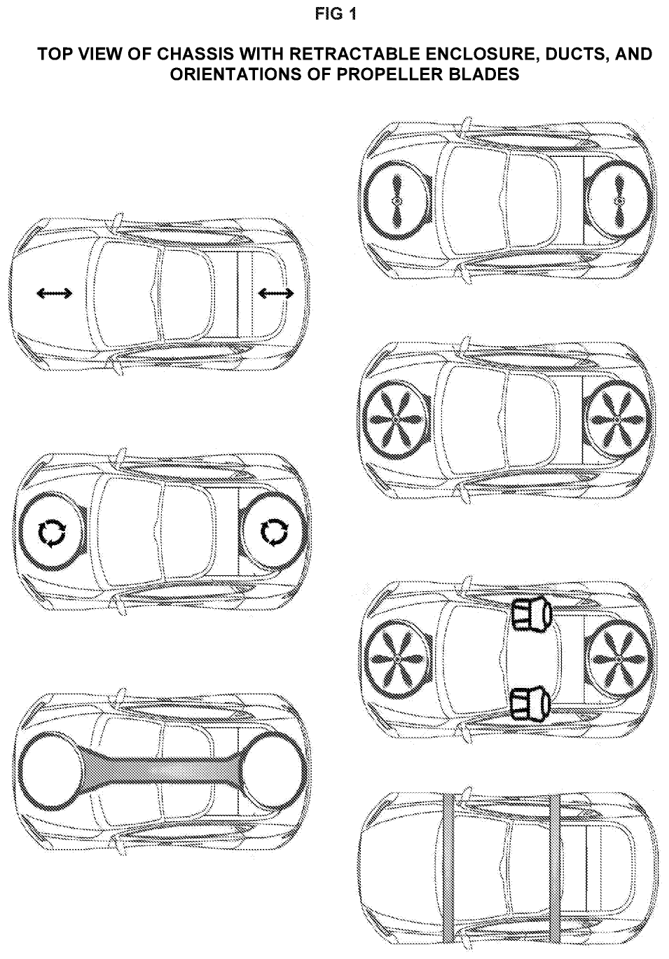

FIG. 1 demonstrates top view of chassis with retractable enclosure, ducts, and orientations of propeller blades.

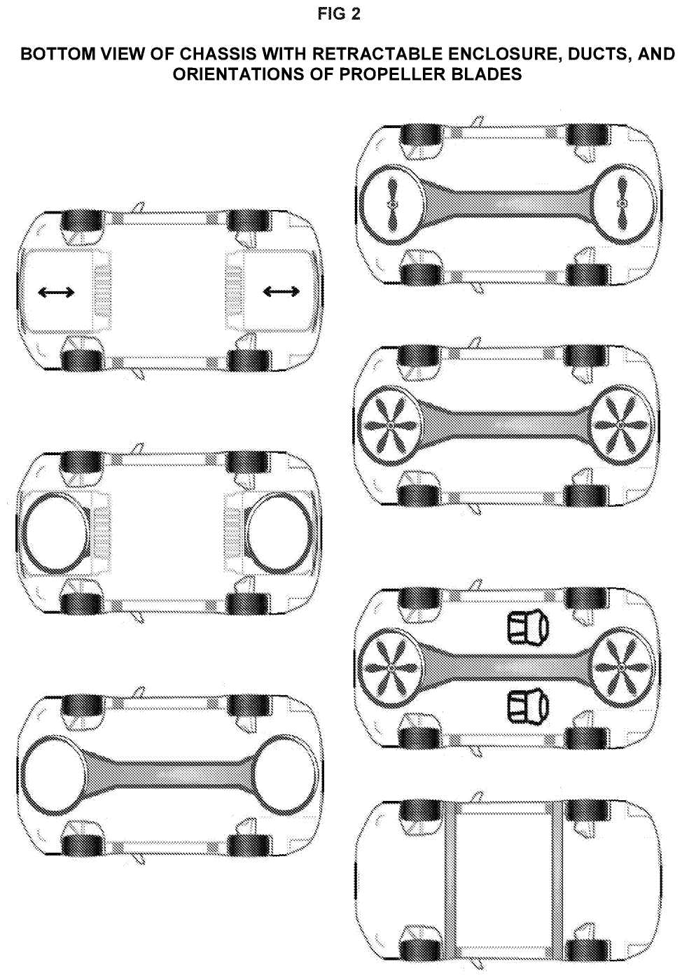

FIG. 2 demonstrates bottom view of chassis with retractable enclosure, Ducts, orientations of propeller blades.

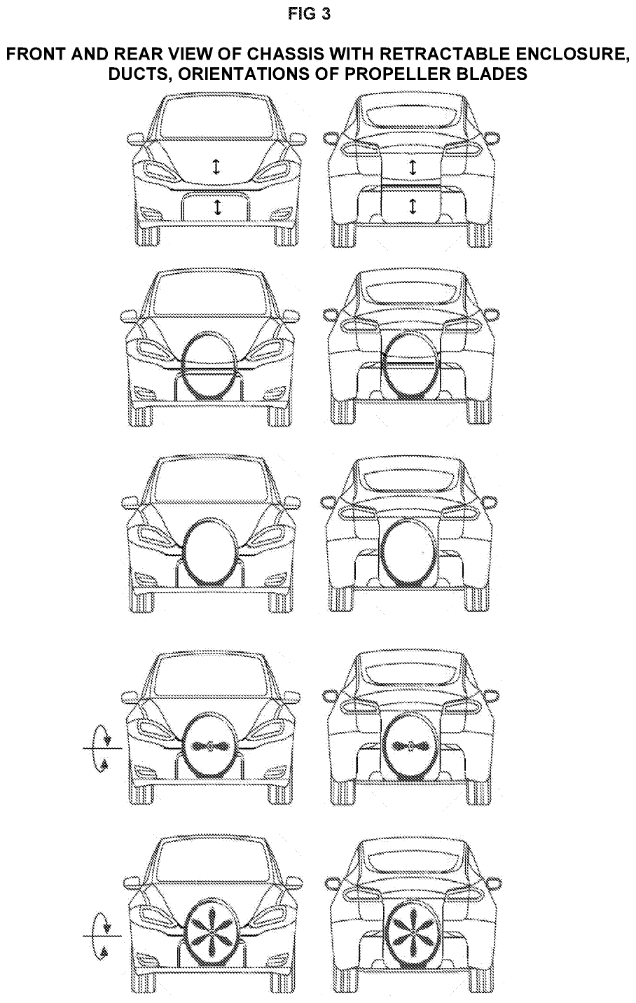

FIG. 3 demonstrates front and rear view of chassis with retractable enclosure, Ducts, orientations of propeller blades.

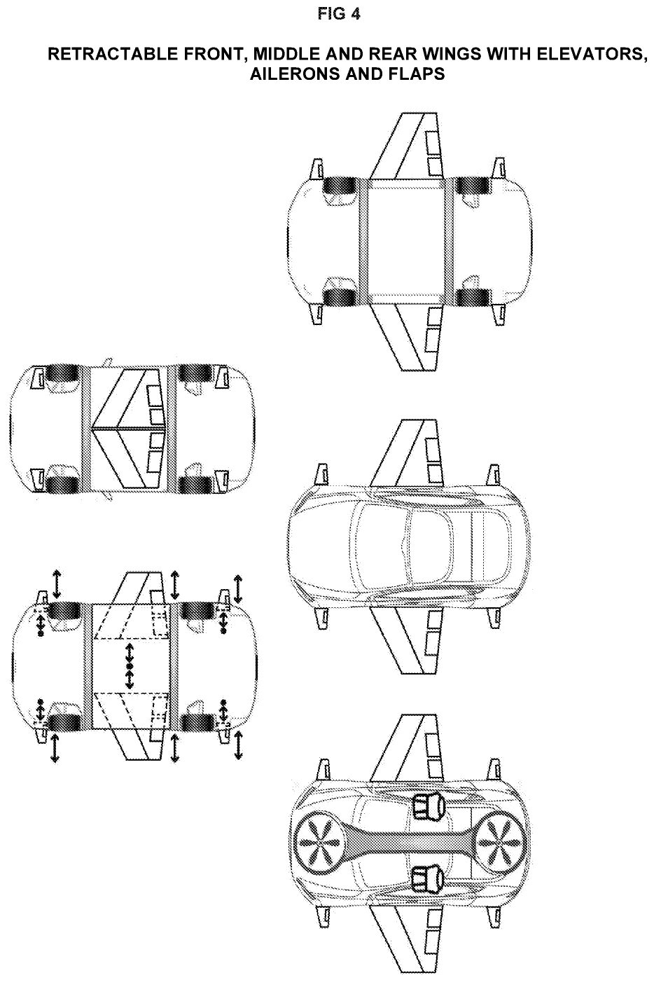

FIG. 4 demonstrates retractable front, middle and rear wings with elevators, ailerons and flaps.

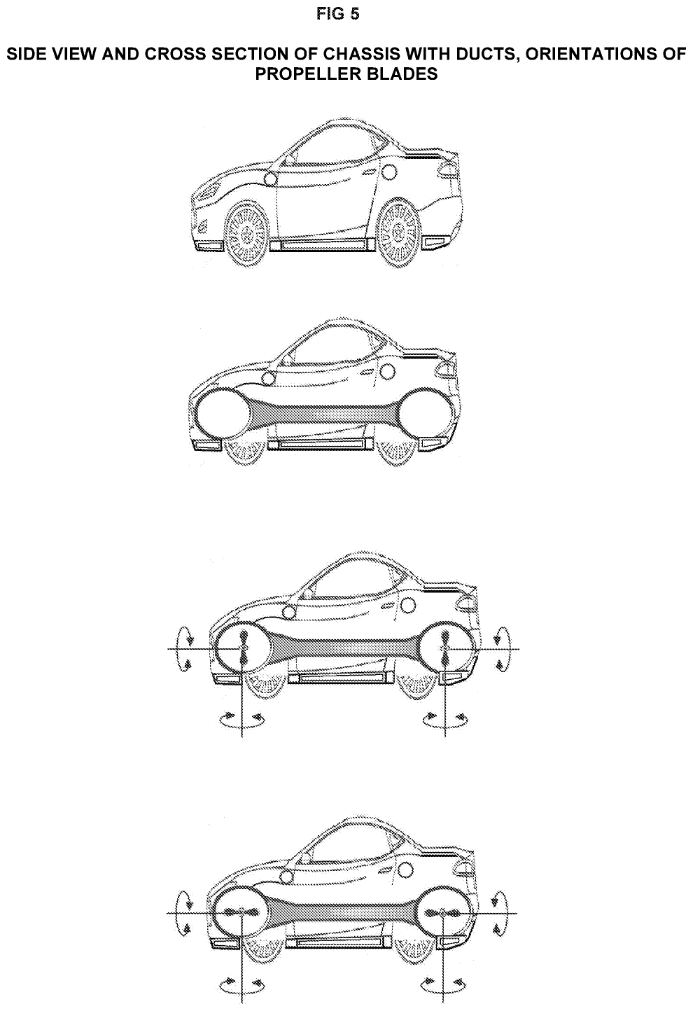

FIG. 5 demonstrates side View and cross section of Chassis with Ducts, orientations of propeller blades.

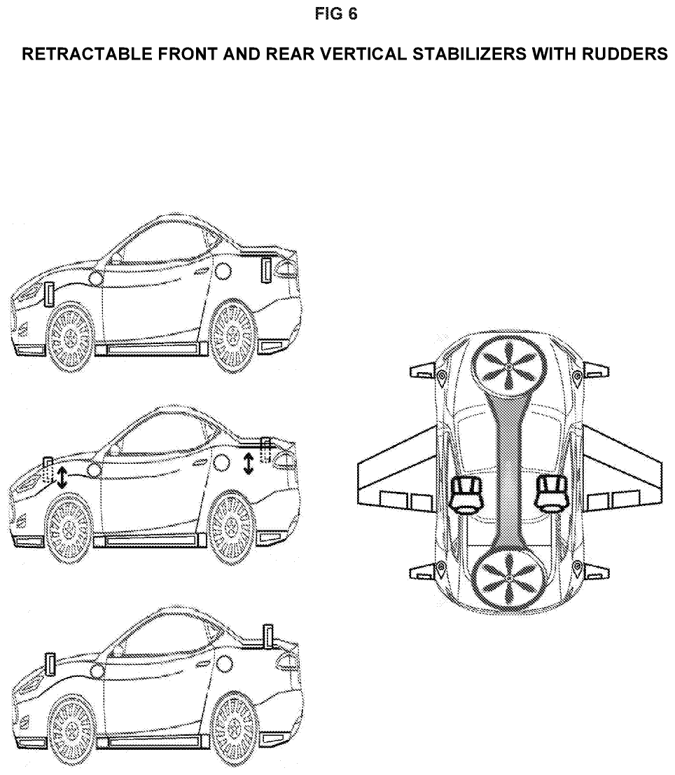

FIG. 6 demonstrates retractable front and Rear vertical stabilizers with rudders.

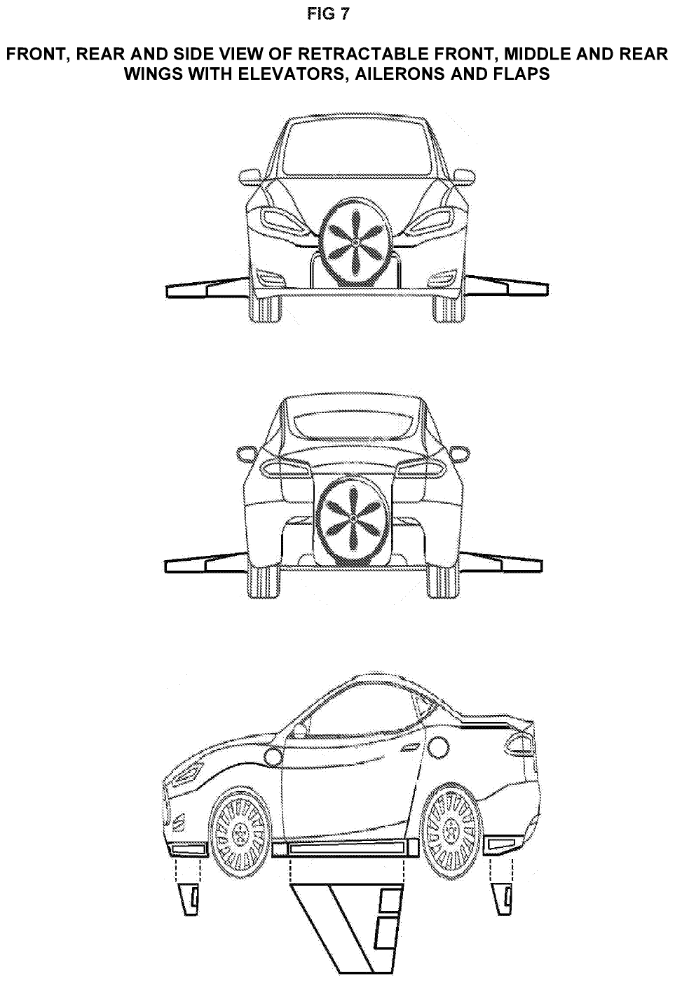

FIG. 7 demonstrates front, rear and side view of retractable front, Middle and Rear wings with elevators, ailerons and flaps.

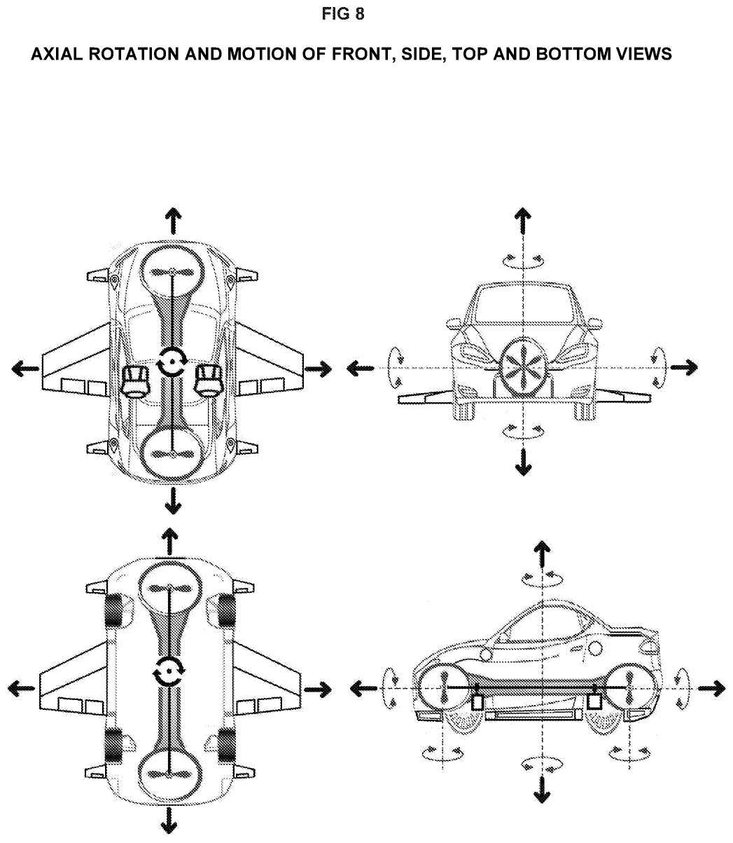

FIG. 8 demonstrates axial rotation and motion of front, side, top and bottom views.

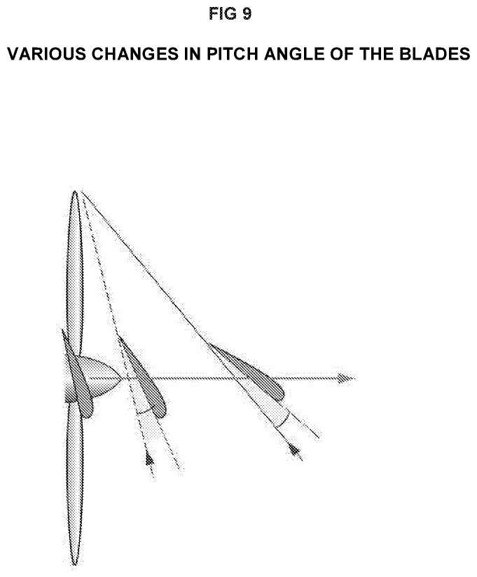

FIG. 9 demonstrates various changes in pitch angle of the blades.

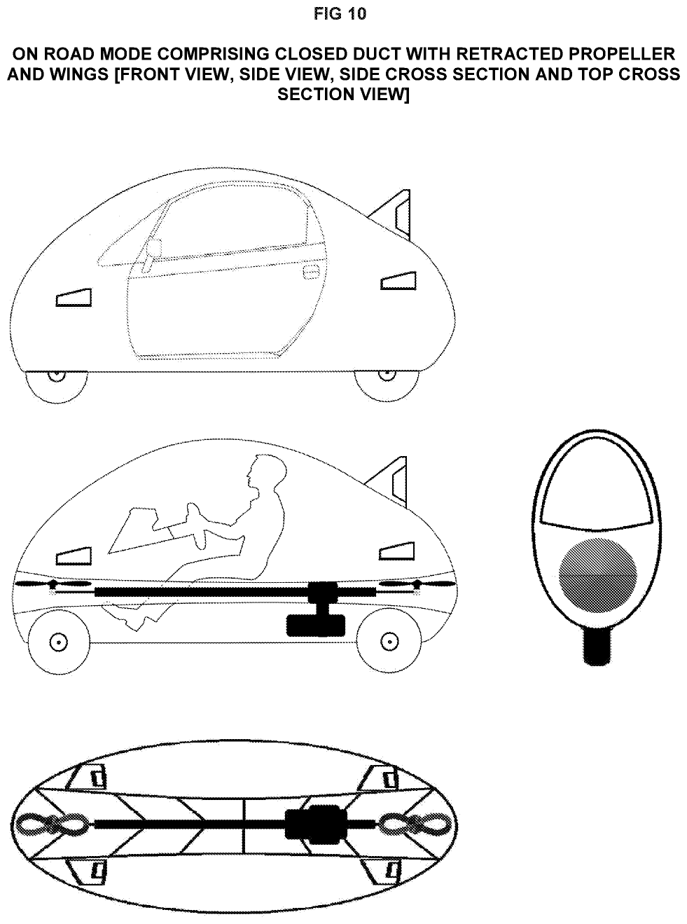

FIG. 10 demonstrates on road mode comprising closed duct with retracted propeller and wings. [Front view, side view, side cross section and top cross section view]

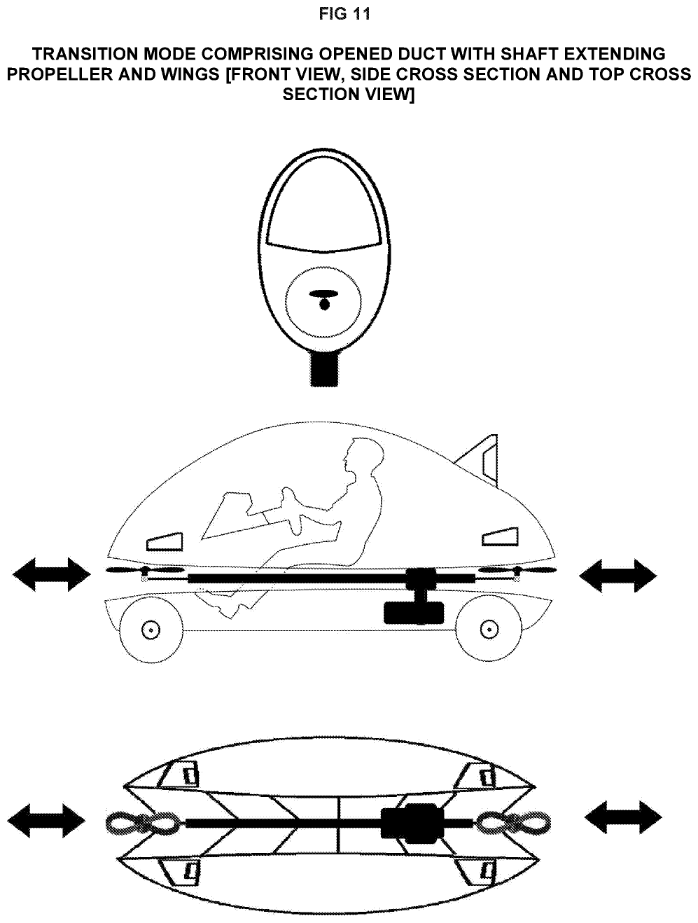

FIG. 11 demonstrates transition mode comprising opened duct with extending shaft propeller and wings. [Front view, side cross section and top cross section view]

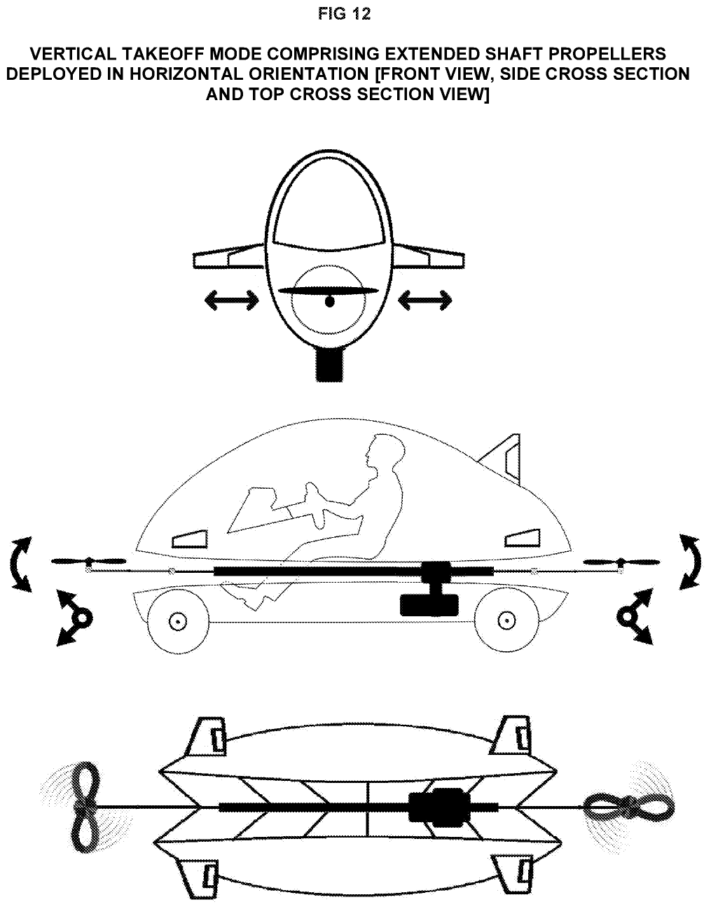

FIG. 12 demonstrates vertical take-off mode comprising extended shaft propellers deployed in horizontal orientation. [Front view, side cross section and top cross section view]

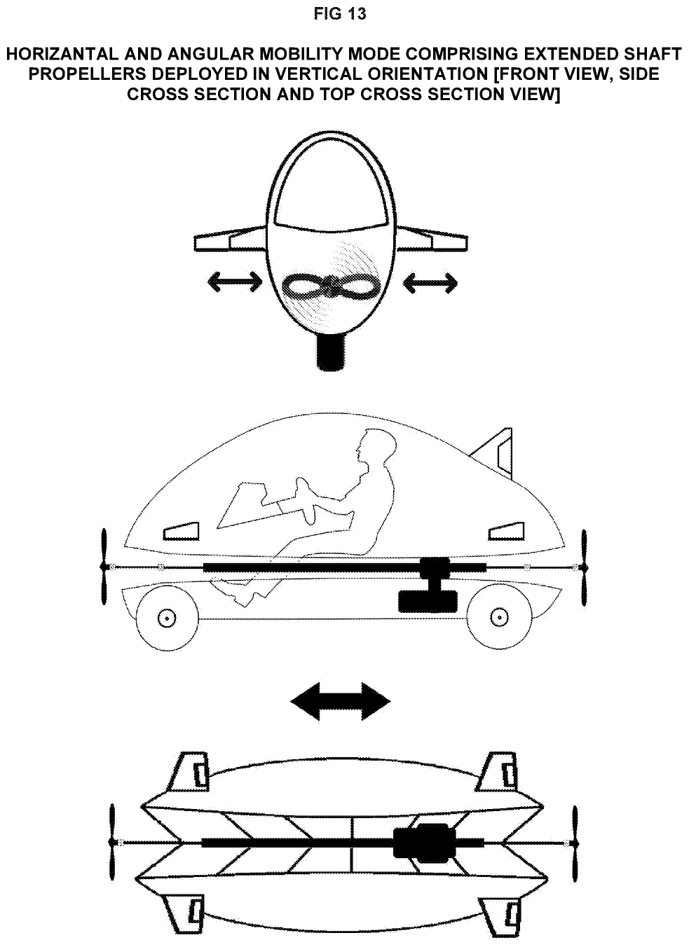

FIG. 13 demonstrates horizontal and angular mobility mode comprising extended shaft propellers deployed in vertical orientation. [Front view, side cross section and top cross section view]

### DESCRIPTION

To address the issues with the other already proposed the present NADTVPMSV provides a highly practical and functional design that makes the single vehicle a perfect road vehicle, perfect air, perfect on water and under water vehicle.

According to one aspect the vehicle chassis comprising longitudinal and transverse ducts with tandem leading and trailing edge integrated with at least one concealed or non-concealed bidirectional thrust vectoring Propeller and Retractable Under Chassis Wings with single to multi directional fluid flow design, control, opening and closing mechanism to control the flight as well as to adapt according to mode of the vehicle.

According to another aspect the longitudinal and transverse duct can be of any length, width, height, dimension, size, shape based on length of the chassis and also to provide more space and accommodate more number of passengers.

According to another aspect other longitudinal and transverse ducts may are may not be inter connected or networked to the main neutral axis longitudinal and horizontal axis ducts.

According to another aspect the ducts may be oblique to longitudinal and transverse vehicle axis.

According to another aspect the transverse ducts are also user to control the transverse motion of the flying car more particularly to assist and maintain stability during strong cross winds.

According to another aspect the design comprises of one or more horizontal single or multi stage retractable section or non-section wings with canards, elevon, elevators, winglets, spoilers, ailerons and flaps integrated in bottom of the chassis. Front, middle and read vertical and horizontal stabilizers with elevators.

According to another aspect the present design may comprises of one or more of single or multi stage retractable or non-retractable front and rear wing horizontal and vertical stabilizer with canards, elevon, winglets, spoilers, ailerons and flaps rudders and elevators.

According to another aspect the present design may comprise of static or dynamic vortex generators that are deployed on the wings, roof top, chassis and stabilizers surfaces to improve the performance and controllability of the flying car.

According to another aspect the design comprises of front, side, middle, under and rear static or dynamic spoilers and diffusers to assist in fluid flow as well as vehicle control.

According to another aspect the present design comprises of one or more thrust vectoring propeller's with or without variable blade angle pitch control with variable thrust directing mechanism.

According to another aspect the present design deploys the retractable wings prior to take off or during take-off or after take-off according to requirement, design, configuration and scenarios.

According to another aspect the present design for safety front and rear propeller shaft are dynamically connected powertrain to optimize the power delivery as well as to compensate for failure, malfunction, loss of power in one powertrain.

According to another aspect to enhance the performance and control additional propellers may or may not be added to the ducts.

According to another aspect of the present design to enhance the performance and control jet propulsion could be added to the duct.

According to another aspect the design comprises of propeller utilising swashplate, pitch links and blade pitch change horn to control the propellers blades angle of attack.

According to another aspect the present design at least one or more of leading, intermediate and trailing propellers are networked and inter connected directly or variably with propeller shaft or drive shaft for torque sharing between propellers.

According to another aspect the present design the propeller has the potential to vary the orientation to 360 degrees on horizontal, vertical and oblique axis.

According to another aspect the present design the propellers act as regenerative propellers to generate and save electricity.

According to another aspect the design with ducts comprises of one or more stator and rotor blades to control fluid flow.

According to another aspect the present design's powertrain comprises or either one or more or combinations but not limited to electric motor, motor turbine, engine, hybrid etcetera.

According to another aspect the present design's the propeller rotor shaft is connected or coupled wirelessly with induction and stator may be integrated along the ducts.

According to another aspect the present design may comprise of at least one or more or combinations of thrust vectoring propeller or turbo fan or turbo jet engines, electric propellers, electric turbines, hybrids etcetera.

According to another aspect the present design's axial rotation and mobility comprises of forward, reverse, up, down, side, yaw, pitch and roll etcetera.

According to another aspect the present design In case of emergency like engine or motor or propeller or system damage/failure or malfunction the safety fluid flow through the interconnected and networked ducts of vehicle and are utilized to distribute and balance the thrust from working propeller for safely landing of the car. Parachute, balloon and under chassis/body airbags to protect the passengers in case of accident. One or more Deployable ejection seat system, parachute and balloon integrated according to the centre of gravity of the vehicle for car protection.

According to another aspect the present design comprises of vehicle suspension system that adapts and assists in landing. Vehicle suspension that control and holds the unspring mass of the wheel tire. A mechanism to cover the exposed wheel tires.

According to another aspect the present design comprises of 360 degree around and all direction environment sensing sensors and navigation system. The system comprises of radar, lidar, gps navigation system, visual and infrared cameras etcetera and have potential to complete autonomous navigation.

The design also comprises of one or more horizontal single or multi stage retractable section or non-section wings with canards, elevon, elevators, winglets, spoilers, ailerons and flaps integrated in bottom of the chassis. Front, middle and rear vertical and horizontal stabilizers with elevators. The present design's axial rotation and mobility comprises of forward, reverse, up, down, side, yaw, pitch, roll and angular motions etcetera.

The embodiments of the present invention is not limited to listed scenarios described here or its combinations and the above presented are just examples. There may be other scenarios and those who skilled in field can understand and modify, enhance, alter the herein system without departing from the scope of the invention in its widest form.

1. I claim a Neutral Axis Duct with Tandem Telescopic Thrust Vectoring Leading and Trailing Bidirectional Edge Propellers for Multi-Mode Spatial Vehicle [NADTVPMSV] which is a single monocoque chassis frame for a multi-mode vehicle that can travel in all land, air, over water and under water as a perfect road vehicle, perfect flying machine, perfect speed boat and perfect submarine comprising of:
a) at least one concealed or non-concealed neutral axis longitudinal duct with or without stationary or rotating blades to extract energy form fluid flow to provide mobilising thrust for vehicle's monocoque chassis frame;
b) at least one tandem thrust vectoring leading and trailing bidirectional edge propellers for providing vertical, horizontal and angular thrust to vehicle's monocoque chassis frame;
c) at least one or more retractable or non-retractable shafts with variable thrust directing mechanism connecting the propellers and power source to power the propellers comprising but not limited to engine, motor and hybrid combination of engine and motor;
d) at least one or more retractable or non-retractable wings with horizontal, vertical and angular control surfaces to control the fluids like water and air thereby to control the vehicles mobility;
e) at least one power source to power the wheels and power the propellers of the vehicle comprising of but not limited to one or more but not limited to engine, motor and hybrid combination of engine and motor;
f) at least one energy source to run the motor or engine comprising of but not limited to either one or combination of fuel and battery;
g) encompasses one or more wheel tires and suspension components for the vehicle with at least one steerable wheel to land and travel on surface;
h) at least one ballast tank to submerge and manoeuvre the vehicle under water;
i) at least one sensor system;
j) at least one processing unit to compute and control the mobility of the vehicle based on the manual inputs and predetermined and tested correlation table inputs.

2. The NADTVPMSV said in claim 1, comprises of at least one gyroscopic moment control system to control the orientation of the vehicle.

3. The NADTVPMSV said in claim 1, may utilises of drive and fly by wire systems for controlling the vehicle.

4. The NADTVPMS said in claim 1, comprises of sensor system to sense the environmental and vehicle parameters to compute and accordingly control the vehicle.

5. The NADTVPMSV said in claim 1, comprises of processing unit to process the sensor system information and manual input information for processing and controlling the vehicle.

6. The NADTVPMSV said in claim 1, comprises of memory to store the vehicle information with predetermined and tested correlation table encompasses parameters between a predetermined and tested real world scenarios in the lab to the actual real world scenarios for the processing unit to check, compute and control the vehicle accordingly.

7. The NADTVPMSV said in claim 1, comprises of radar and RF communication system to scan the environment and establishing communication.

8. The NADTVPMSV said in claim 1, the longitudinal and transverse duct can be of any length, width, height, dimension, size, shape based on length of the chassis and also to provide more space and accommodate more number of passengers.

9. The NADTVPMSV said in claim 1, the longitudinal and transverse ducts may or may not be inter connected or networked to the main neutral axis longitudinal and horizontal axis ducts.

10. The NADTVPMSV said in claim 1, the ducts may be oblique to longitudinal and transverse vehicle axis where the transverse ducts may be used to control the transverse motion of the flying car more particularly to assist and maintain stability during strong cross winds.

11. The NADTVPMSV said in claim 1, may comprises of one or more of single or multi stage retractable or non-retractable front and rear wing horizontal and vertical stabilizer with canards, elevon, winglets, spoilers, ailerons and flaps rudders and elevators.

12. The NADTVPMSV said in claim 1, may comprise of static or dynamic vortex generators that are deployed on the wings, roof top, chassis and stabilizers surfaces to improve the performance and controllability of the flying vehicle.

13. The NADTVPMSV said in claim 1, may comprises of front, side, middle, under and rear static or dynamic spoilers and diffusers to assist in fluid flow as well as vehicle control.

14. The NADTVPMSV said in claim 1, comprises of one or more thrust vectoring propeller's with or without variable blade angle pitch control with variable thrust directing mechanism.

15. The NADTVPMSV said in claim 1, for safety front and rear propeller shaft are dynamically connected one or more powertrains to optimize the power delivery as well as to compensate for failure, malfunction, and loss of power in one propeller powertrain.

16. The NADTVPMSV said in claim 1, to enhance the performance and control additional propellers may or may not be added to the ducts.

17. The NADTVPMSV said in claim 1, to enhance the performance and control jet propulsion could be added to the duct.

18. The NADTVPMSV said in claim 1, comprises of at least one or more of leading, intermediate and trailing propellers are networked and inter connected directly or variably with propeller shaft or drive shaft for torque sharing between propellers.

19. The NADTVPMSV said in claim 1, design the propeller has the potential to vary the orientation to 360 degrees on horizontal, vertical and oblique axis.

20. The NADTVPMSV said in claim 1, the propeller rotor shaft is connected or coupled wirelessly with induction and stator may be integrated along the ducts.
